(19) United States
(12) Patent Application Publication
(10) Pub. No.: US 2026/0156368 A1
(43) Pub. Date: Jun. 4, 2026

(54) Object-Based High-Dynamic-Range Image Capturing

(71) Applicant: Google LLC, Mountain View, CA (US)

(72) Inventor: Vickie Youmin Wu, Santa Clara, CA (US)

(73) Assignee: Google LLC, Mountain View, CA (US)

(21) Appl. No.: 18/838,477

(22) PCT Filed: Jul. 20, 2023
(86) PCT No.: PCT/US2023/070605

§ 371 Date: Aug. 14, 2024

(51) Int. Cl. H04N 23/741; H04N 23/61; H04N 23/661; H04N 23/73

(52) U.S. Cl. CPC H04N 23/741; H04N 23/61; H04N 23/661; H04N 23/73

(57) ABSTRACT

This document describes systems and techniques for object-based high-dynamic-range image capturing. In aspects, an image-capturing device can adjust an electronic shutter speed for one or more units of pixels of an image sensor based on luminous level statistical information of detected objects in a captured frame. In this way, the one or more units of pixels configured with modified electronic shutter speeds can capture incident light of a scene in a successive frame with adapted exposure for each object.

### BACKGROUND

Many personal electronic devices come equipped with advanced display technology, reliable communication systems, and multiple compact digital camera assemblies. These personal electronic devices are often manufactured in aesthetic and portable design profiles, minimizing an overall size or thickness of the personal electronic device where possible. To provide all these features, personal electronic devices must often include digital camera assemblies that are smaller than digital camera assemblies in standalone digital cameras. Moreover, personal electronic devices often omit camera hardware components sometimes found in larger, professional-style standalone cameras, such as manual exposure controls and manual focus. Yet users of personal electronic devices still desire visually appealing images on par with those of standalone digital cameras. As a result, these compact digital camera assemblies in personal electronic devices must accommodate for a wide variety of lighting and scene situations with limited or no interaction from the user and must accomplish image capturing in the most computationally-effective and cost-effective manner.

### SUMMARY

This document describes systems and techniques that enable object-based high-dynamic-range image capturing. In aspects, the method includes the following: generating a first downsampled grayscale image based on a first frame that includes pixel data of a first scene; performing object detection on the first downsampled grayscale image sufficient to detect one or more objects within the first scene; determining one or more first object boundaries for each of the one or more detected objects; collecting, responsive to the determination of the one or more first object boundaries, luminous level statistical information of regions defined by each of the one or more first object boundaries; zoning the first frame based on the luminous level statistical information sufficient to form at least one zone, the at least one zone corresponding to at least one first unit of pixels of a pixel array at an image sensor; and adjusting an electronic shutter speed of the at least one first unit of pixels sufficient to increase or decrease an exposure time.

In additional aspects, a computing system is disclosed that includes a pixel array of an image sensor, one or more processors, and computer-readable instructions which, when executed by the processor, cause the computing system to perform the aforementioned method.

In further aspects, non-transitory computer-readable media is disclosed that includes computer-readable instructions which, when executed by a processor, cause a computing system to perform the aforementioned method.

This Summary is provided to introduce simplified concepts concerning object-based high-dynamic-range image capturing, which is further described below in the Detailed Description and Drawings. This Summary is not intended to identify essential features of the claimed subject matter, nor is it intended for use in determining the scope of the claimed subject matter.

### BRIEF DESCRIPTION OF THE DRAWINGS

The details of one or more aspects of object-based high-dynamic-range image capturing are described in this document with reference to the following drawings. The same numbers are used throughout the drawings to reference like features and components:

FIG. 1 illustrates an example environment in which a user uses a limited dynamic range image-capturing device to capture a first scene with a low dynamic range and a second scene with a high dynamic range.

FIG. 2 illustrates an example environment in which systems and techniques for object-based high-dynamic-range image capturing can be implemented.

FIG. 3 illustrates an example implementation of an image-capturing device that can implement object-based high-dynamic-range image capturing.

FIG. 4 illustrates an exploded view of components of an example camera system.

FIG. 5 illustrates an example implementation of the example camera system being operatively coupled to one or more processors.

FIG. 6 illustrates an example implementation of the image capture manager from FIG. 3 in more detail.

FIG. 7 illustrates an example implementation of an example image-capturing device implementing object-based high-dynamic-range image capturing.

FIG. 8 illustrates an example implementation of a front-facing image sensor of the example image-capturing device of FIG. 7.

FIG. 9 illustrates an additional example implementation of the image capture manager zoning a frame into multiple zones.

FIG. 10 illustrates an example implementation of a front-facing image sensor with a pixel array.

FIG. 11 illustrates an example method of object-based high-dynamic-range image capturing in accordance with some implementations.

FIG. 12 illustrates various components of an example computing system 1200 that can be implemented as any type of client, server, and/or electronic device as described with reference to the previous FIGS. 1-11 to implement object-based high-dynamic-range image capturing.

### DETAILED DESCRIPTION

### Overview

Original equipment manufacturers of various electronic devices, such as smartphones and laptops, often embed one or more cameras in electronic devices (“image-capturing devices”) that enable a user to capture a static image (a single frame) or videos (multiple frames per second (FPS)) of a scene. A lighting of a scene, including a range of brightness levels (dynamic range) present in the scene, significantly influences the ability of these image-capturing devices to capture and reproduce (e.g., digitally) a captured frame. For instance, a scene with a wide range of brightness levels (a high dynamic range (HDR) scene), such as a scene with a bright background and a dark foreground, can be difficult for an image-capturing device to reproduce with quality. As described herein, a quality of a captured frame may refer to at least one of an aesthetic value (e.g., vivid coloring, enhanced lighting), a realistic accuracy (e.g., natural colors, natural lighting), or a level of detail (e.g., contrast, exposure).

In more detail, image-capturing devices may have a limited ability to capture a full range of brightnesses in a scene (limited dynamic range). As a result, a user who is attempting to capture an HDR scene using an image-capturing device with a limited dynamic range may be disappointed by a resulting image that is too bright in some portions (e.g., overexposed) and/or too dark in other portions (e.g., underexposed). For example, a user may use an image-capturing device with a limited dynamic range to capture a sunset over waves of an ocean while on a beach. Due to the brightness of the sun and the darkness of the ocean (e.g., an HDR scene), the image-capturing device with the limited dynamic range may reproduce an image with minimal detail, including a white portion depicting the sun and a black portion depicting shadows of the ocean.

To generate images with a broader range of tones and details, image-capturing devices may employ a real-time HDR technique, a staggered HDR (sHDR) technique, or an intra-scene dual conversion gain (iDCG) technique. For example, the real-time HDR technique can enable an image-capturing device to capture an HDR scene in a single exposure by combining multiple exposures of different brightness levels into a single image. In another example, the sHDR technique, also referred to as exposure bracketing, can involve the image-capturing device capturing a series of images at different exposure levels and combining these images (e.g., post-process) to produce an HDR image. In still another example, the iDCG technique can involve the image-capturing device using two different conversion gain settings within a single exposure: a lower conversion gain to capture details in highlights and a higher conversion gain to capture details in shadows. Through such a technique, an image sensor can optimize a signal-to-noise ratio and increase an overall dynamic range of a captured frame.

Such techniques, however, can have their downsides. For example, one or more of these techniques may introduce motion artifacts into a captured frame. In another example, one or more of these techniques may require high data bandwidth, require more processing time, and result in greater power expenditure. In a still further example, an in-pixel conversion can limit the iDCG technique's flexibility to provide more-flexible ratios.

In contrast, this document describes systems and techniques for object-based high-dynamic-range image capturing. In aspects, an image-capturing device can adjust an electronic shutter speed for one or more units of pixels of an image sensor based on luminous level statistical information of detected objects in a captured frame. In this way, the one or more units of pixels configured with modified electronic shutter speeds can capture incident light of a scene in a successive frame with adapted exposure for each object.

Additional examples and implementations are described throughout this document. The document now turns to an example operating environment, after which example environments, devices, implementations, methods, and systems are described.

### Operating Environment

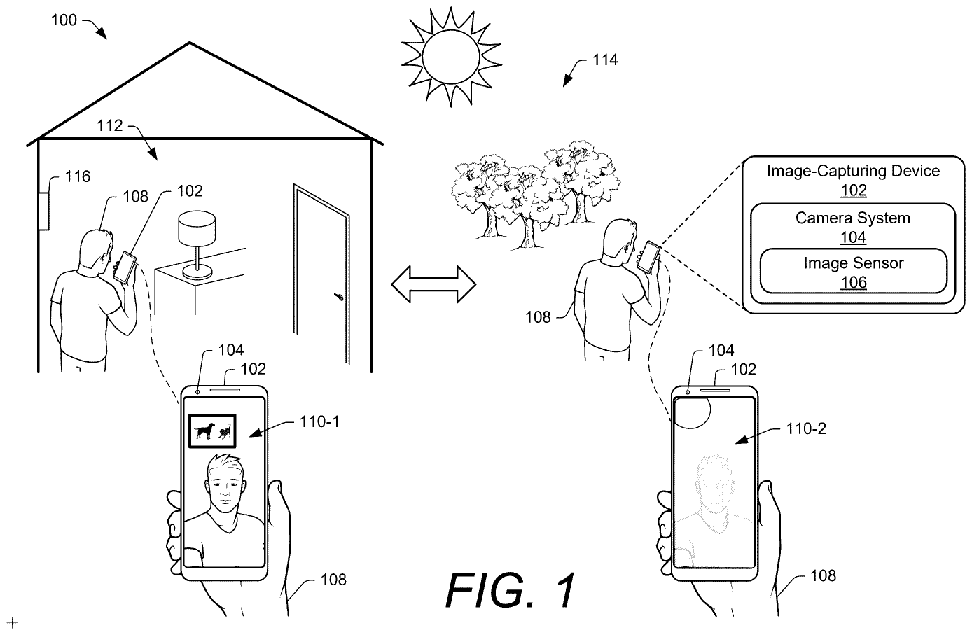

FIG. 1 illustrates an example environment 100 in which a user 108 uses a limited dynamic range image-capturing device to capture a first scene with a low dynamic range and a second scene with a high dynamic range. The example environment 100 includes an image-capturing device 102 (e.g., a smartphone), which includes a camera system 104 having an image sensor 106.

In the illustrated example, the user 108 captures a first frame 110-1 in an indoor area 112 with a lighting condition that has a low dynamic range. Later, the user 108 captures a second frame 110-2 in an outdoor area 114 with a lighting condition that has a high dynamic range. In some examples, a source of light in the indoor area 112 may originate from artificial lighting, such as incandescent lightbulbs or light-emitting diodes (LEDs). Most artificial lighting in an indoor environment, such as the indoor area 112, provides a lighting condition that is 300 to 700 lumens, whereas in an outdoor environment, on a bright, sunny day, a lighting condition can range from 1,000 to 6,000 lumens. For instance, in an outdoor environment, a brightness in a shady area, such as under a tree, can be 1100 lumens, while a brightness in an open clearing can be as much as 5,000 lumens.

While in the indoor area 112, the image sensor 106 of the camera system 104 may capture frames, such as the first frame 110-1, with a high quality due to a scenic low dynamic range, among other factors. As illustrated, the image sensor 106 captures a scene and the image-capturing device 102 generates the first frame 110-1. The first frame 110-1 may contain sufficient information (e.g., digital pixel data, photosensitive film content) about the scene such that details about the scene are discernible (e.g., a good quality). For instance, facial features of the user 108, who is in a foreground, and features of objects in a background, including a painting of dogs 116, may be discernible due to a good image contrast and brightness and low blur (e.g., a life-like representation).

While in the outdoor area 114, however, the image sensor 106 of the camera system 104 may capture frames, such as the second frame 110-2, with a low quality largely due to a scenic high dynamic range. As illustrated, the image-capturing device 102 captures a scene and the image-capturing device 102 generates the second frame 110-2. The second frame 110-2 may contain little-to-no discernible details about the scene (e.g., a low quality). For instance, details of objects in a foreground or in a background may not be discernible. It is significant to note that the low quality of the second frame 110-2 may not result solely from the high luminosity of the sun. Instead, the low quality of the second frame 110-2 may be, in large part, a result of the high dynamic range within the scene. For example, as illustrated in FIG. 1, because a back portion of the body of the user 108 is receiving incident light from the sun, a front portion of the body of the user 108 may be obscured, at least partially, by a shadow. This may result in a scene with a high dynamic range.

In an attempt to increase a quality of the second frame 110-2 and minimize an influence of the bright sun, a user (on the image-capturing device) may try reducing an exposure of the camera system 104. However, in so doing, the second frame 110-2 may lose even more detail of the face of the user 108, causing portions of the second frame 110-2 to be even more underexposed. On the other hand, a user may try to increase an exposure of the camera system 104 to possibly increase a level of detail of the face of the user 108. However, this may result in “blown-out” regions within the frame 110-2, causing more portions of the second frame 110-2 to be overexposed.

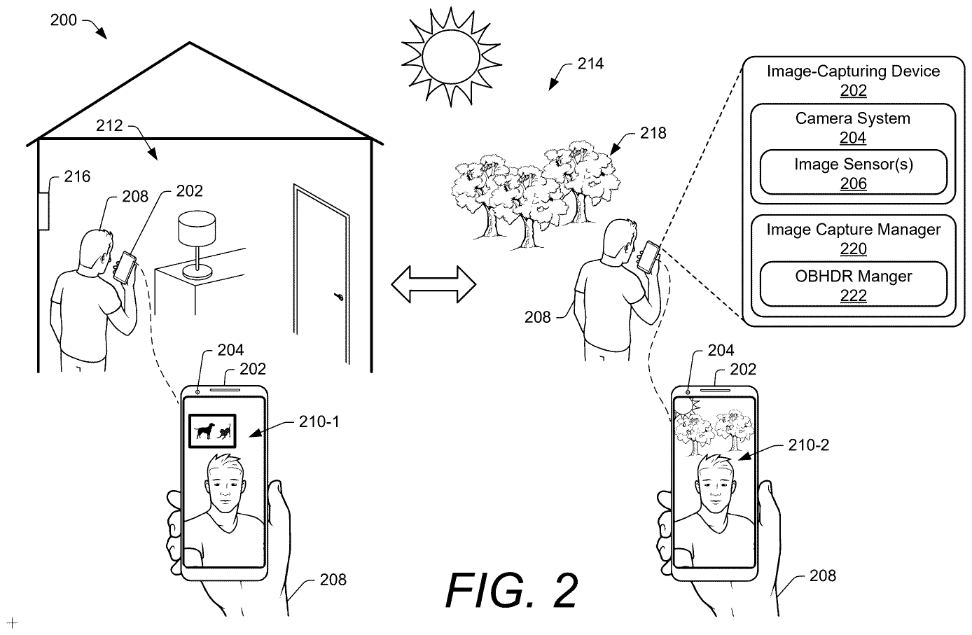

FIG. 2 illustrates an example environment 200 in which systems and techniques for object-based high-dynamic-range image capturing can be implemented. The example environment 200 includes an image-capturing device 202 (e.g., a smartphone), which includes, or is operably coupled to, a camera system 204 having an image sensor 206. The image-capturing device 202 further includes an image capture manager 220 having an object-based high-dynamic-range (OBHDR) manager 222.

As further described below, the image capture manager 220 having the OBHDR manager 122 is configured to implement one or more aspects of object-based high-dynamic-range image capturing. In aspects, an image-capturing device can adjust an electronic shutter speed for one or more units of pixels of an image sensor based on luminous level statistical information of detected objects in a captured frame. In this way, the one or more units of pixels configured with modified electronic shutter speeds can capture incident light of a scene in a successive frame with adapted exposure for each object.

Similarly to in the example environment 100 of FIG. 1, FIG. 2 illustrates a user 208 capturing a first frame 210-1 in an indoor area 212 with a lighting condition that has a low dynamic range. FIG. 2 also illustrates the user 208 capturing a second frame 210-2 in an outdoor area 214 with a lighting condition that has a high dynamic range. While in the indoor area 212, the image sensor 206 captures a scene and the image-capturing device 202 generates the first frame 210-1. The first frame 210-1 may contain sufficient information (e.g., digital pixel data, photosensitive film content) about the scene such that details about the scene are discernible (e.g., a good quality). For instance, facial features of the user 208, who is in a foreground, and features of objects in a background, including a painting of dogs 216, may be discernible due to a good image contrast and brightness and low blur (e.g., a life-like representation).

While in the outdoor area 214, the image sensor 206 of the camera system 204 captures a scene and the image-capturing device 202 generates the second frame 210-2. The second frame 210-2 may also contain sufficient information about the scene such that details about the scene are discernible, despite the high dynamic range. For instance, facial features of the user 208, who is in a foreground, and features of objects in a background, including trees 218, may be discernible due to a good image contrast, brightness, and low blur. To achieve a high-quality image (or at least a higher-quality image than the second frame 110-2), the image capture manager 220 may utilize the OBHDR manager 222 as described in further detail below.

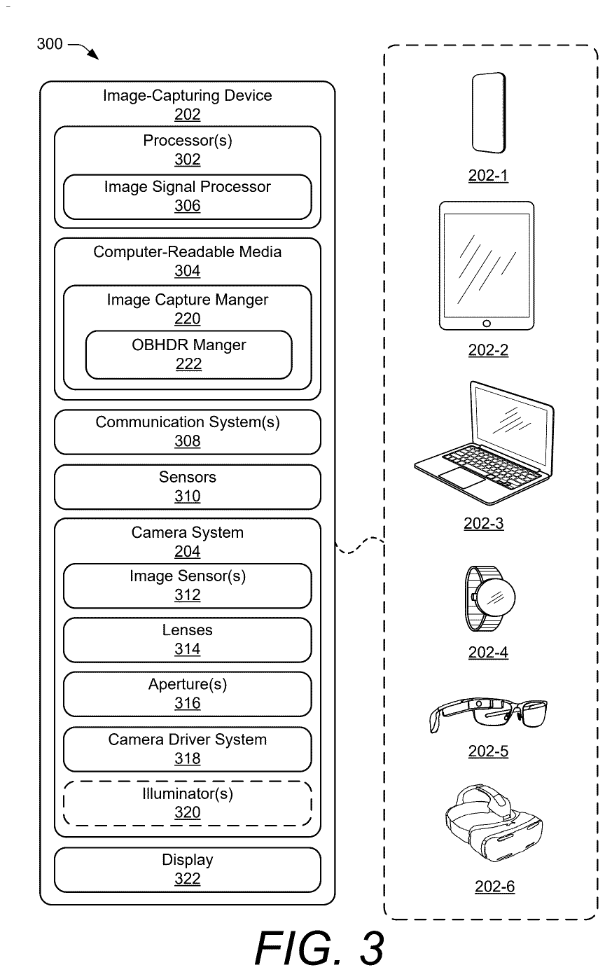

Consider FIG. 3, which illustrates an example implementation 300 of the image-capturing device 202 that can implement object-based high-dynamic-range image capturing. The image-capturing device 202 of FIG. 3 is illustrated with a variety of example devices, including a smartphone 202-1, a tablet 202-2, a laptop 202-3, a computing watch 202-4, computing spectacles 202-5, and an artificial reality/virtual reality (AR/VR) headset 202-6. Although not shown, the image-capturing device 202 may also be implemented as any of a mobile station (e.g., fixed- or mobile-STA), a mobile communication device, a client device, a home automation and control system, an entertainment system, a gaming console, a personal media device, a health monitoring device, a drone, a camera, an Internet home appliance capable of wireless Internet access and browsing, an Internet of Things device, security systems, and the like. Note that the image-capturing device 202 can be wearable, non-wearable but mobile, or relatively immobile (e.g., desktops, appliances). Note also that the image-capturing device 202 can be used with, or embedded within, electronic devices or peripherals, such as in automobiles or as an attachment to a laptop computer. The image-capturing device 202 may include components or interfaces omitted from FIG. 3 for the sake of clarity or visual brevity.

In some implementations, the image-capturing device 202 includes a printed circuit board assembly (PCBA) on which components and interconnects of the image-capturing device 202 are embodied. Alternatively or additionally, components of the image-capturing device 202 can be embodied on other substrates, such as flexible circuit material or other insulative material, and, optionally, can be operatively coupled to the PCBA. The image-capturing device 202 may also include a housing that defines at least one internal cavity. In implementations, the housing may be supported and/or defined by a frame. The housing includes an exterior surface and an opposing interior surface. The exterior surface may include at least one portion in contact with a physical medium (e.g., hair, skin, tissue, clothing) associated with a user or a physical medium (e.g., mount, pad) associated with auxiliary equipment. For example, the computing watch 202-4 can include an exterior surface in contact with a charging stand. In another example, the smartphone 202-1 can include an exterior surface in contact with a hand of a user. In aspects, the housing may be any of a variety of plastics, metals, acrylics, or glasses. In an implementation, the exterior surface of the housing includes one or more openings, such as a port (e.g., a barometric port).

As illustrated, the image-capturing device 202 includes one or more processors 302 and computer-readable media 304. The processors 302 may include any suitable single-core or multi-core processor (e.g., an application processor (AP), a digital-signal processor (DSP), a central processing unit (CPU), a graphics processing unit (GPU), a computer vision and machine-learning (CVML) processor). The processors 302 may be configured to execute instructions or commands stored within the computer-readable media 304. In an example implementation, the image-capturing device 202 includes a multi-core system-on-chip (SoC) that is configured to parallelly execute instructions or commands stored within the computer-readable media 304. Applications and/or an operating system (not shown) implemented as computer-readable instructions on the computer-readable media 304 can be executed by the computer processors 302 to provide some or all of the functionalities described herein. For example, the computer-readable media 304 can include the image capture manager 220 and the OBHDR manager 222. The computer-readable media 304 may be stored within one or more non-transitory storage devices such as a random access memory (RAM, dynamic RAM (DRAM), non-volatile RAM (NVRAM), or static RAM (SRAM)), a read-only memory (ROM), a or flash memory), a hard drive, a solid-state drive (SSD), or any type of media suitable for storing electronic instructions, each coupled with a computer system bus. The term “coupled” may refer to two or more elements that are in direct contact (physically, electrically, magnetically, optically, etc.) or to two or more elements that are not in direct contact with each other but still cooperate and/or interact with each other.

At least one processor of the one or more processors 302 includes an image signal processor 306 (e.g., image processing engine, image processing unit (IPU), image processor). In an example implementation, the image signal processor 306 can be operatively coupled to, or integrated within, a multi-core SoC. The image signal processor 306 may be a dedicated processing unit that is responsible for converting raw image data to a digital image, as well as processing and enhancing image data captured by a camera system. In some examples, the image signal processor 306 can perform demosaicing (e.g., to reconstruct full-color information), noise reduction, white balance, tone mapping and dynamic range compression, sharpening and detail enhancement, image stabilization, and compression and encoding.

The image-capturing device 202 may further include and/or be operatively coupled to communication systems 308. The communication systems 308 enable communication of device data, such as received data, transmitted data, or other information as described herein, and may provide connectivity to one or more networks and other devices connected therewith. Example communication systems include NFC transceivers, WPAN radios compliant with various IEEE 802.15 (Bluetooth®) standards, WLAN radios compliant with any of the various IEEE 802.11 (WiFi®) standards, WWAN (3GPP-compliant) radios for cellular telephony, wireless metropolitan area network (WMAN) radios compliant with various IEEE 802.16 (WiMAX®) standards, infrared (IR) transceivers compliant with an Infrared Data Association (IrDA) protocol, and wired local area network (LAN) Ethernet transceivers. Device data communicated over the communication systems 308 may be packetized or framed depending on a communication protocol or standard by which the image-capturing device 202 is communicating. The communication systems 308 may include wired interfaces, such as Ethernet or fiber-optic interfaces for communication over a local network, a private network, an intranet, or the Internet. Alternatively or additionally, the communication systems 308 may include wireless interfaces that facilitate communication over wireless networks, such as wireless LANs, cellular networks, or WPANs.

Further illustrated, the image-capturing device 202 includes a plurality of sensors 310 to obtain information regarding a local environment of the image-capturing device 202. For example, the sensors 310 can include any of a variety of sensors, such as an audio sensor (e.g., a microphone), a touch-input sensor (e.g., a touchscreen), proximity sensors (e.g., capacitive sensors, radar sensors), a depth sensor (e.g., a range estimator), or an ambient light sensor (e.g., photodetector).

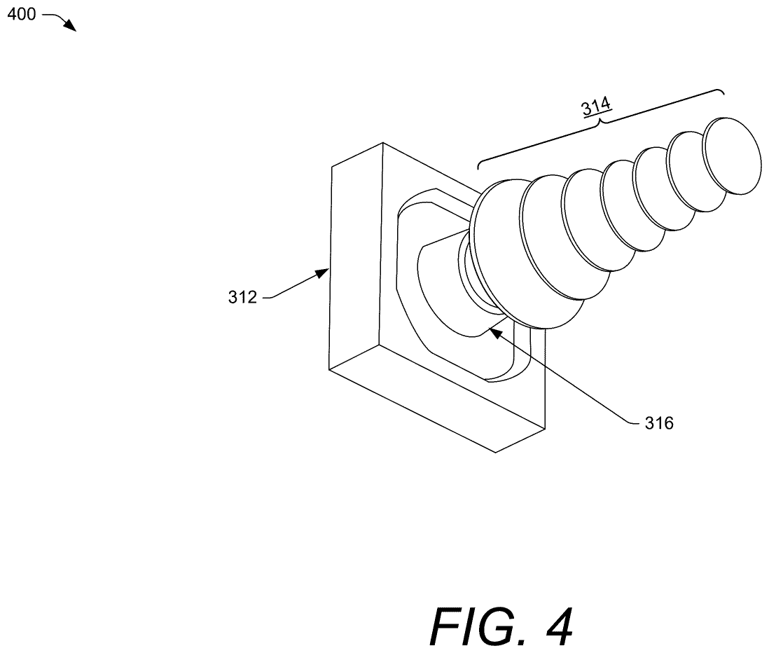

The image-capturing device 202 further includes a camera system 204 having one or more image sensors 312, lenses 314, and apertures 316. Consider FIG. 4, which illustrates an exploded view 400 of components of an example camera system 204. Components of the camera system 204 may be disposed partially or fully within the housing of the image-capturing device 202. In implementations, the housing of the image-capturing device 202 includes an opening in which, or behind which, one or more components of the respective camera system 204 may reside.

The one or more image sensors 312 can be implemented as, for example, a complementary metal oxide semiconductor (CMOS) or a charge-coupled device (CCD) sensor. In aspects, the one or more image sensors 312 are configured to capture incident light, such as light reflected off of one or more objects in a scene, and generate a digital signal (e.g., data relating to light of a captured scene). In implementations, the image sensor 312 includes light-sensitive materials, micro-lens(es), and/or micro-electrical components. For example, a CMOS image sensor may include a micro-lens array, a color filter array (CFA), a photodiode layer, pixel transistors, one or more bonding layers, and/or an application-specific integrated circuit (ASIC). In more detail, the micro-lens array may include small lenses that collect and focus light onto light-sensitive areas of the CMOS image sensor. The CFA may be a patterned layer that includes a mosaic of tiny color filters placed over one or more photosites (sometimes referred to as pixels) to capture color information. The CFA may allow different wavelengths of light to pass through to the photosites. As an example, a CFA pattern may include a Bayer filter, which consists of red, green, and blue filters. A respective photosite of the one or more photosites may be an individual light-sensitive area that captures light and converts it into an electrical signal. In some implementations, each photosite may correspond to a single pixel in a digitally reproduced image of a scene. The photosites may be arranged to form a pixel array (e.g., in a grid pattern). Each photosite includes a photodiode, defining the photodiode layer. Each of the photodiodes may be composed of a semiconductor material, such as silicon. The photodiodes may experience a photoelectric effect (e.g., emission of electrons in response to electromagnetic radiation) due to incident light from a scene. Pixel transistors can then receive electrical signals from each of the photodiodes. The pixel transistors may provide gain and/or buffer of electrical charge from the photodiodes. The ASIC may be implemented as a logic layer and may include readout circuitry, timing and control circuitry, and an output interface. The readout circuitry may convert an accumulated electrical charge from each of the photodiodes into a digital signal. As an example, the readout circuitry may include one or more amplifiers, analog-to-digital converters (ADCs), and signal processing circuits. The timing and control circuitry controls the operation and timing of the image sensor 312, including exposure time, pixel readout, and synchronization with other hardware components of the image sensor 312 and/or the image-capturing device 202. The output interface enables data transmission from the image sensor 312 to other hardware components, such as one or more processors and memory.

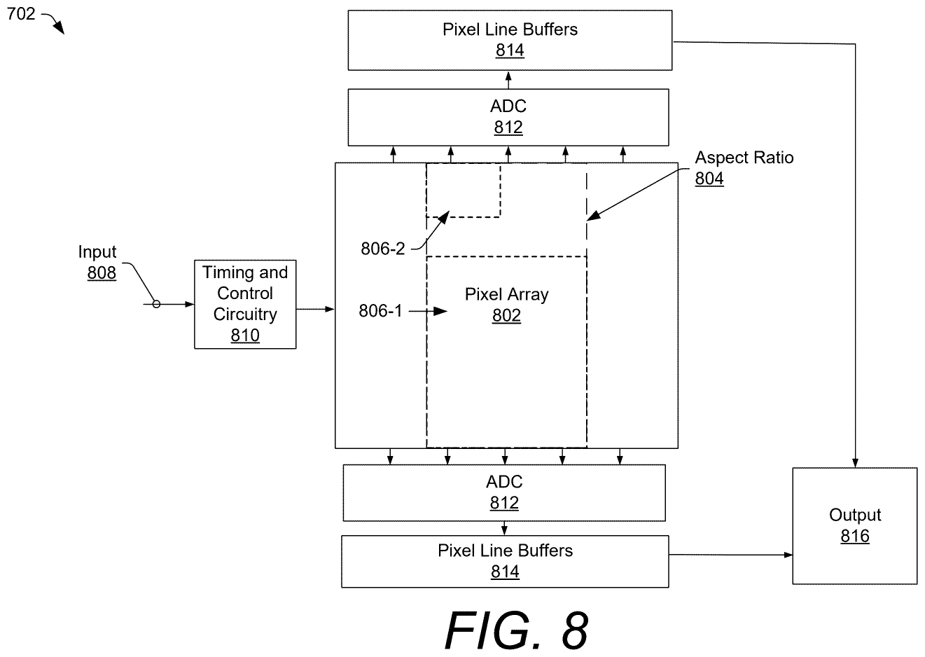

In an implementation, the image sensor 312 can comprise a stacked sensor arrangement with embedded memory. In this way, the image sensor 312 can read out a pixel individually when, for example, its integration finishes. In an additional implementation, additional line buffers may be included in the image sensor 312 to accommodate a large unit of pixels (e.g., see first unit of pixels 806-1 of FIG. 8). In a further implementation, the image-capturing device 202 can include a global control to arbitrate and schedule a pixel readout sequence. In this way, one or more processors 302 can receive a frame in a raster scan order.

The lenses 314 can include, for example, glass lenses or plastic lenses (e.g., elements), which focus light of a scene on the one or more image sensors 312. By adjusting a distance between the lenses 314 and/or a distance between the one or more lenses 314 and a respective image sensor 312, the camera system 204 can alter a magnification (e.g., zoom in, zoom out) and adjust a level of focus of a scene. Although FIG. 4 illustrates the example camera system 204 as having seven lenses 314, the number of lenses 314 may vary for each of the one or more image sensors 312.

The camera system 204 may further include an aperture 316 for each of the one or more image sensors 312. In implementations, a respective aperture 316 is configured to adjust an amount of incident light at a respective image sensor 312 by adjusting a size of an opening through which light from a scene travels. An aperture 316 may also influence a depth of field (DOF) in a digitally reproduced image.

Turning back to FIG. 3, the camera system 204 further includes a camera driver system 318 and, optionally, one or more illuminators 320 (e.g., camera flash bulbs). The camera driver system 318 (e.g., an output interface of a respective image sensor) enables communication between the camera system 204 and other components of the image-capturing device 202, such as the processor(s) 302 and computer-readable media 304. The camera driver system 318 can be initiated by any suitable trigger, such as a user input received via an actuated control or pressed button (e.g., a graphical user interface (GUI) button), or a signal received from one or more sensors 310. The camera driver system 318 can also control settings for the camera system 204, including settings for gain, white balance, focus, zoom, image stabilization, and exposure duration, in response to commands from the processor(s) 302.

In implementations, one or more of these hardware components of the camera system 204, including the image sensor(s) 312, lenses 314, and aperture(s) 316, may be adjusted manually by a user (e.g., via commands provided at a user interface, via physical adjustment) and/or automatically by one or more algorithms stored in the computer-readable media 304 and executed by the one or more processors 302. For example, a respective aperture of the one or more apertures 316 can be automatically controlled by an auto-exposure algorithm. The auto-exposure algorithm can calculate and adjust exposure parameters (e.g., an exposure time, a gain, an f-number) based on an exposure value.

In additional examples, one or more lenses 314 and/or one or more apertures 316 can be automatically controlled by an auto-focus algorithm. In one example, the camera system 204 can be operably coupled to a range estimator, which can determine a distance from an object to the camera system 204 so that the auto-focus algorithm can automatically adjust a focus of the camera system 204. In another example, the focus of the camera system 204 may be adjusted by a passive autofocus technique. The passive autofocus technique may use image data captured at a respective image sensor 312 to determine whether an image is in focus and adjust one or more lenses 314 to compensate. For instance, the passive autofocus technique can involve an autofocus algorithm detecting a contrast within image data and adjusting a focus until the contrast is maximized. In still another example, the focus of the camera system 204 may be adjusted by a phase-detection autofocus technique.

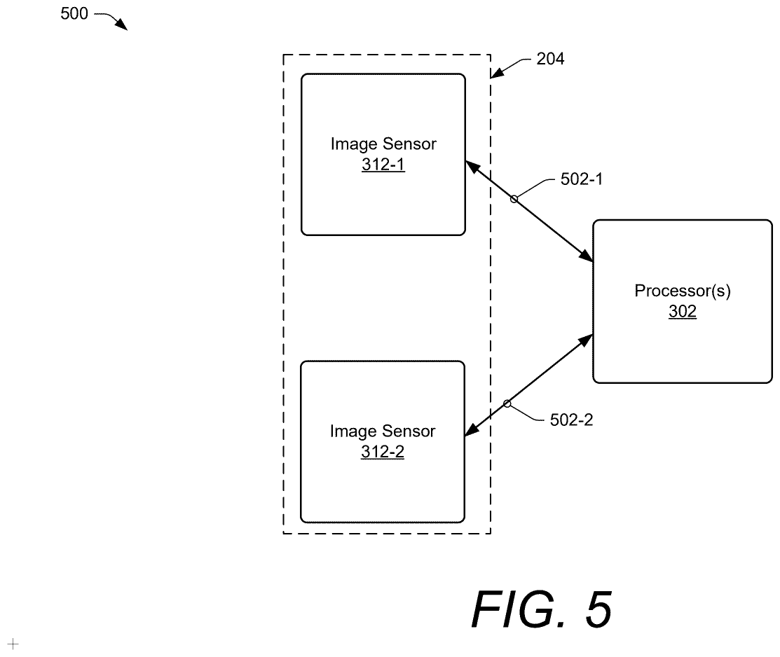

FIG. 5 illustrates an example implementation 500 of the camera system 204 being operatively coupled to one or more processors 302. As illustrated, for example only and not by way of limitation, the camera system 204 includes two image sensors 312 (e.g., first image sensor 312-1, second image sensor 312-2). Further, for example only and not by way of limitation, each of the two image sensors 312 are operatively coupled to one or more processors 302. In some implementations, at least one of the one or more processors 302 is integrated within a multi-core SoC and at least one of the image sensors 312 is operatively coupled to the at least one processor 302 via connection to the multi-core SoC.

As illustrated, each of the one or more image sensors 312 may be operatively coupled to the one or more processors 302 via a mobile industry processor interface (MIPI) interface 502 (e.g., first MIPI interface 502-1, second MIPI interface 502-2). For instance, the first image sensor 312-1 may be operatively coupled to the one or more processors 302 via the first MIPI interface 502-1 (e.g., a single-lane MIPI), while the second image sensor 312-2 may be operatively coupled to the one or more processors 302 via the second MIPI interface 502-2 (e.g., a multi-lane MIPI). One or more of the MIPI interfaces 502 may be a camera serial interface (CSI), such as MIPI CSI-2. Alternatively or additionally, one or more of the MIPI interfaces 502 may be an inter-integrated circuit, such as an MIPI I2C or MIPI I3C.

In an example implementation, lenses of the first image sensor 312-1 are integrated on a front-facing portion of the image-capturing device 202 and lenses of the second image sensor 312-2 are integrated on a rear-facing portion of the image-capturing device 202. In this way, the image-capturing device 202 includes a front-facing camera and a rear-facing camera to capture a first scene of a region in front of the image-capturing device 202 and a second scene of a region behind the image-capturing device 202.

Turning back to FIG. 3, momentarily, the image-capturing device 202 can also include a display 322. The display 322 can include any suitable visual display device, such as a liquid crystal display (LCD), a thin film transistor (TFT) LCD, an in-place switching (IPS) LCD, a capacitive touchscreen display, an organic light-emitting diode (OLED) display, an active-matrix organic light-emitting diode (AMOLED) display, a super AMOLED display, and so forth. The display 322 may be referred to as a screen, such that content may be displayed on-screen. For example, responsive to execution of instructions in the computer-readable media 304, the one or more processors 302 can direct the display 322 to present a static image (a single frame) or a video (multiple FPS) of a scene as captured by the camera system 204.

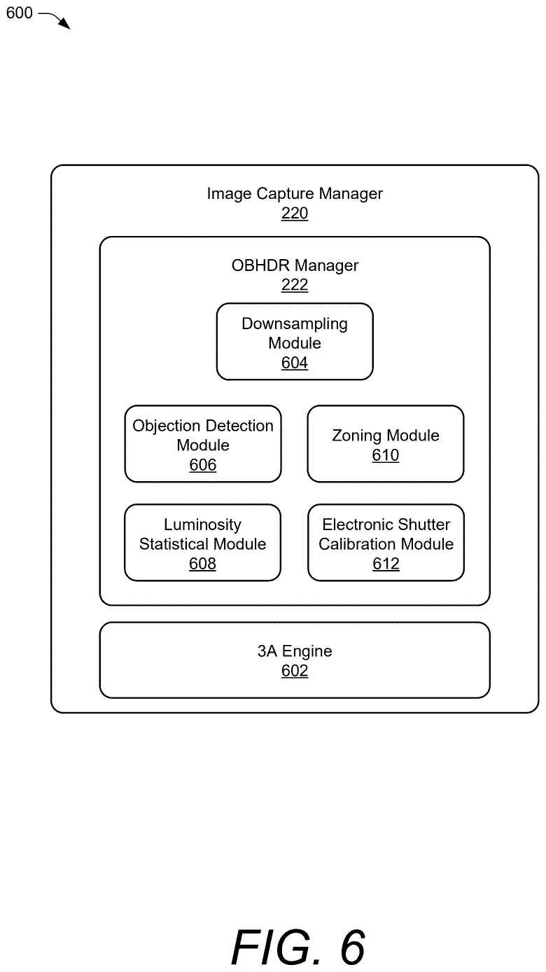

FIG. 6 illustrates an example implementation 600 of the image capture manager 220 from FIG. 3 in more detail. Although FIG. 6 shows various entities and components as part of the image capture manager 220, any of these entities and components may be separate from the image capture manager 220 such that the image capture manager 220 accesses and/or communicates with them to manage object-based high-dynamic-range image capturing. Further, various implementations of the image capture manager 220 and/or components and entities therein can include an SoC, one or more integrated circuits (ICs), a processor with embedded processor instructions or configured to access processor instructions stored in memory, hardware with embedded firmware, one or more algorithms, machine-learned techniques, or any combination thereof. For example, execution of the image capture manager 220 can occur partially, or completely, on the image signal processor 306, one or more CPUs, an application processor, a multi-core SoC, and so on.

As illustrated in FIG. 6, the image capture manager 220 includes the OBHDR manager 222 and a “3A” (auto-focus, auto-white balance, auto-exposure) engine 602. The OBHDR manager 222 may include a downsampling module 604, an object detection module 606, a luminosity statistical module 608, a zoning module 610, and an electronic shutter calibration module 612. Although not illustrated, the image capture manager 220 can also include additional entities and components, such as a facial recognition module for face authentication.

In aspects, the image capture manager 220 obtains a frame captured by a respective image sensor of the one or more image sensors 312. The image capture manager 220 can then use the downsampling module 604 to generate a downsampled grayscale image based on the obtained frame. As an example, the image capture manager 220 reduces the resolution and/or size of the obtained frame and converts it to a single-channel grayscale image. In additional implementations, the image capture manager 220 can calculate a sampling ratio, based on a complexity of a scene, to determine how many pixels from the obtained frame are to be combined into a single pixel in the downsampled grayscale image.

The image capture manager 220 may then utilize the object detection module 606 of the OBHDR 222 to detect objects in the downsampled grayscale image. For example, execution of the object detection module 606 can be performed by a CVML processor. In implementations, the object detection module 606 is configured (e.g., trained) to detect only major objects (e.g., large objects, prominent objects), major and minor objects (e.g., small objects, less prominent objects), or objects of interest. Objects of interest can, in some implementations, be objects that are of interest to a user (e.g., based on customized user preferences, learned user preferences, and/or preprogrammed standard preferences). In further implementations, objects of interest can be objects that are of interest insofar as they are objects that the object detection module 606 is trained specifically to detect. In this way, the size and number of objects may be configurable. Moreover, detected objects may be weighted based on, for example, a proximity to the image-capturing device 202 and/or a context (e.g., whether an object in a scene is performing an action). For example, the object detection module 606 can be configured to ignore small or insignificant objects, such as a leaf on a tree or a cup on a table. In additional examples, the object detection module 606 can be configured to detect scenery, such as, for example, landscapes, fallen snow, a sky (e.g., a blue sky), a body of water, clouds, stars, biological matter, and so on. In still further implementations, the object detection module 606 can be configured to identify objects (e.g., person recognition) and/or features (e.g., facial feature identification).

By analyzing the downsampled grayscale image, the object detection module 606 can process fewer pixels, leading to faster inference times and enhanced computational efficiency. These benefits can be even more pronounced when the respective image sensor 312 captures multiple frames. Further, the downsampled grayscale image may have reduced noise compared to the obtained frame, expediting object detection.

In at least some implementations, upon detecting objects, the object detection module 606 can determine one or more object boundaries. In an example, the obtained frame can include pixel data of a scene in which a user stands in a foreground with the sun in a background. Upon analysis of the downsampled grayscale image, the object detection module 606 can determine an object boundary for the sun and an object boundary for the user. Object boundaries may be simple (e.g., rectangular, circular, polygonal) or complex (e.g., an outline of a user) shapes.

In addition, the image capture manager 220 can use the luminosity statistical module 608 of the OBHDR manager 222 to collect luminous level statistical information (e.g., brightness or intensity values) of the scene from at least one of the obtained frame, the downsampled grayscale image, or one or more sensors 310. In implementations, the luminosity statistical module 608 can collect luminous level statistical information for each of the detected objects based on the one or more object boundaries. For example, responsive to the object detection module 606 determining one or more object boundaries, the luminosity statistical module 608 can apply one or more of said object boundaries to the obtained frame and determine luminous level statistical information for at least one of the detected objects. Optionally, the luminosity statistical module 608 can determine luminous level statistical information for one or more regions surrounding the detected objects.

The luminous level statistical information can, for example, include one or more of a mean (e.g., average value of the brightness or intensity values), a standard deviation (e.g., measure of the dispersion, distribution, or variability of the brightness or intensity values), a minimum and maximum (e.g., a range of values), a histogram, or a skewness and kurtosis (e.g., shape and symmetry of the brightness distribution). The luminous level statistical information can be for regions within the one or more object boundaries, for the entire obtained frame, and/or for regions outside of the one or more object boundaries.

Further to the above descriptions, the image capture manager 220 can use the zoning module 610 of the OBHDR manager 222 to zone (e.g., divide) the obtained frame, defining one or more zones. In implementations, the zoning module 610 can divide the frame into different zones based on at least one of a type of detected object or luminous level statistical information. For example, the zoning module 610 may zone regions of the obtained frame based on the types of the detected objects, such as a person or the sun, and/or based on luminous level statistical information, such as an underexposed object or an overexposed object. In one example, the obtained frame may represent a scene having a person in a foreground and the sun in a background. The zoning module 610 can zone a first region of the obtained frame based on the detected sun and zone a second region of the obtained frame based on luminous level statistical information within an object boundary applied to the person. Alternatively, the zoning module 610 can zone both the first region and the second region based on the detected objects alone or the luminous level statistical information alone.

In implementations, the zoning module 610 may be any type of algorithm, including a machine-learned technique. The size, shape, and number of zones into which the obtained frame may be zoned (e.g., divided) can be configurable based on at least one of a processing speed of the one or more processors 302, an electrical power level of the image-capturing device 202, a sensitivity (e.g., a number of pixels) of a respective image sensor 312 from which the frame was obtained, a size of the respective image sensor 312 from which the frame was obtained, a complexity of a scene (e.g., a number of objects, a large range of values in the luminous level statistical information), or a camera driver system 318 setting. For instance, zones may include tens, hundreds, or thousands of pixels (e.g., image pixels) and form simple or complex shapes. Further, the zoning module 610 may zone one to hundreds of regions within the obtained frame. In one example, the zoning module 610 can zone the obtained frame into three rectangular zones based on at least one of the types of detected objects or the luminous level statistical information. In an additional example, the zoning module 610 can zone the obtained frame into tens of rectangular zones based on luminous level statistical information of a region within one or more object boundaries. For instance, a region defined by an object boundary can be divided into multiple zones, including smaller simple or complex shapes, based on luminous level statistical information.

Further, the image capture manager 220 can use the electronic shutter calibration module 612 of the OBHDR manager 222 to calculate an appropiate exposure time for each zone. Each zone may correspond to a unit of pixels on a respective image sensor. For example, three rectangular zones that equally divide an obtained frame can correspond to a first M×N unit of pixels on a respective image sensor, a second M×N unit of pixels on the respective image sensor, and a third M×N unit of pixels on the respective image sensor. In some instances, “M” may be equal to “N”. Execution of the electronic shutter calibration module 612 can be performed by the image signal processor 306. Further, implementation of a calculated exposure time for each zone can be carried out by the camera driver system 318 (e.g., at a timing and control circuitry of an ASIC of a respective image sensor).

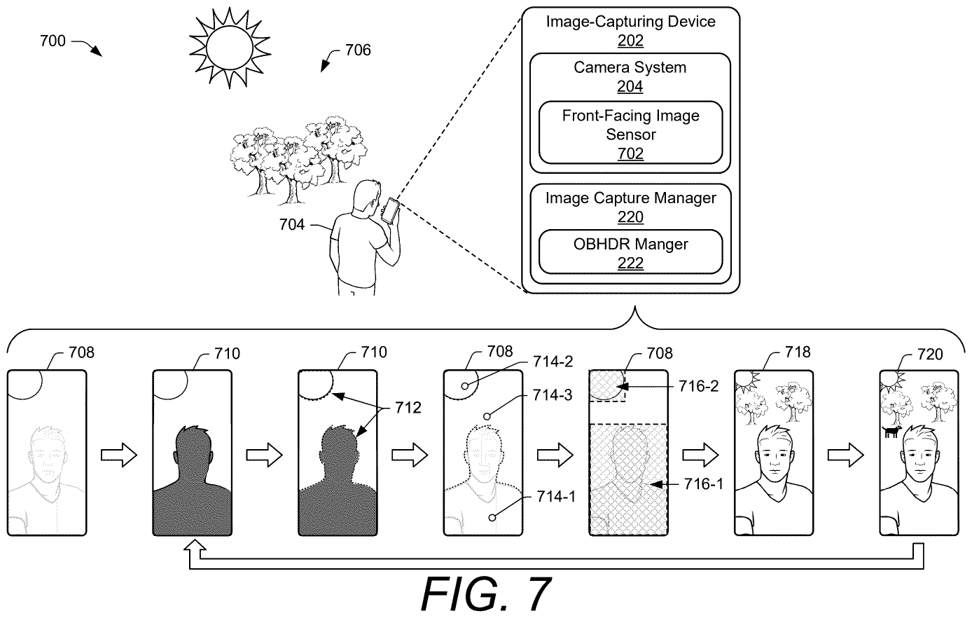

These and other capabilities and configurations, as well as ways in which entities of FIG. 6 act and interact, are set forth in greater detail below. These entities may be further divided, combined, and so on. The environment 200 of FIG. 2, the example implementation 300 of FIG. 3, and the detailed illustrations of FIG. 7 through FIG. 10 illustrate some of many possible environments and devices capable of employing the described techniques.

### Example Implementations

FIG. 7 illustrates an example implementation 700 of an example image-capturing device 202 implementing object-based high-dynamic-range image capturing. The example implementation 700 illustrates the image-capturing device 202 having a camera system 204 and a front-facing image sensor 702 of one or more image sensors (e.g., one or more image sensors 312). The image-capturing device 202 further includes an image capture manager 220 having an OBHDR manager 222.

As illustrated, a user 704 is in an environment 706 (e.g., an outdoor area) with a lighting condition that has a high dynamic range. For instance, the lighting condition may include a bright sun and a shadow that covers (e.g., obscures) a front portion of the user 704. While in the environment 706, the user 704 may desire to capture a photo using the front-facing image sensor 702. To this end, the user may activate a photo application on the image-capturing device 202 (e.g., stored in computer-readable media 304). Upon activation of the photo application, the image capture manager 220 may then, using a camera driver system 318, activate and adjust lenses 314, a respective aperture of one or more apertures 316, and/or the front-facing image sensor 702. Before, during, and/or after said activation and adjustment, the image capture manager 220 may cause the front-facing image sensor 702 to capture one or more frames of a scene that includes the user 704 in the environment 706.

In aspects, the image capture manager 220 may obtain a respective frame 708 (e.g., a first frame, a sampling every “n” frame) of the one or more frames. The image capture manager 220 can then generate a downsampled grayscale image 710 based on the respective frame 708 using a downsampling module 604 of the OBHDR manager 222. Next, the image capture manager 220 can utilize an object detection module 606 of the OBHDR 222 to detect one or more objects in the downsampled grayscale image 710. Upon detecting the one or more objects, the object detection module 606 may determine one or more object boundaries 712. The image capture manager 220 can then apply the one or more object boundaries 712 to the respective frame 708. Then, the image capture manager 220 can use a luminosity statistical module 608 of the OBHDR manager 222 to collect luminous level statistical information of the scene. In an implementation, the luminosity statistical module 608 determines luminous level statistical information for (i) a first region 714-1 within the frame 708 bounded by a first object boundary of the one or more object boundaries 712, (ii) a second region 714-2 within the frame 708 bounded by a second object boundary of the one or more object boundaries 712, and, optionally, (iii) a third region 714-3 that surrounds the first region 714-1 and the second region 714-2.

Based on the luminous level statistical information for at least one of the three regions 714 and/or a location of the one or more object boundaries 712 within the respective frame 708, the image capture manager 220 can zone the obtained frame into two zones 716 (e.g., a first zone 716-1, a second zone 716-2) using a zoning module 610 of the OBHDR manager 222. As illustrated, for example only, the zoning module 610 can zone the respective frame 708 into the two zones 716 (zones illustrated as hatched regions defined by dashed lines). In implementations, the two zones 716 may not be equally sized, nor may the two zones 716 equally divide the respective frame 708. In additional implementations, the zones 716 may surround at least portions of the regions 714 defined by the one or more object boundaries 712. In further implementations, the size, shape, and number of zones 716 into which the respective frame 708 may be zoned can be configurable based on at least one of a processing speed of one or more processors 302, an electrical power level of the image-capturing device 202, a sensitivity (e.g., a number of pixels) of the front-facing image sensor 702, a size of the front-facing image sensor 702, a complexity of a scene (e.g., a number of objects, a large range of values in the luminous level statistical information), or a camera driver system 318 setting.

Further to the above descriptions, the two zones 716 in the respective frame 708 may correspond to two units of pixels on the front-facing image sensor 702. Consider, for example, FIG. 8, which illustrates an example implementation of the front-facing image sensor 702 from FIG. 7. As illustrated, the front-facing image sensor 702 includes a pixel array 802 (e.g., one or more photosites). In implementations, the zoning module 610 can determine a corresponding unit of pixels 806 for each number of zones 716. For example, as illustrated, the zoning module 610 determines, in accordance with an aspect ratio 804 associated with the respective frame 708, a first unit of pixels 806-1 corresponding to the first zone 716-1 and a second unit of pixels 806-2 corresponding to the second zone 716-2.

For at least one of the units of pixels 806 and, optionally, pixels surrounding the units of pixels 806, an electronic shutter calibration module 612 of the OBHDR manager 222 can calculate an appropiate exposure time. For example, based on the luminous level statistical information for the first region 714-1 and the second region 714-2, the electronic shutter calibration module 612 can calculate an exposure time for each unit of pixels 806 that may enable the first region 714-1 and the second region 714-2 to be well illuminated (e.g., not overexposed, not underexposed) in a successive frame. Based on the calculation(s), the electronic shutter calibration module 612 can adjust an exposure time for at least one of the first unit of pixels 806-1, the second unit of pixels 806-2, or pixels surrounding the unit of pixels 806.

As an example, calculations performed by the electronic shutter calibration module 612 can be executed on an image signal processor 306. Next, the image signal processor 306, via the camera driver system 318, can adjust the exposure time for each unit of pixels 806 based on the calculations. In implementations, the image signal processor 306 adjusts the exposure time for each unit of pixels 806 by transmitting an input 808 to timing and control circuitry 810 (e.g., programmable registers) of an ASIC associated with the front-facing image sensor 702. In this way, a successive frame can be captured using adjusted electronic shutter speeds. The input 808 may be transmitted from the image signal processor 306 over a respective MIPI interface (e.g., an MIPI I2C interface, an MIPI I3C interface) of one or more MIPI interfaces 502. Further, the input 808 may include instructions for an electronic shutter speed for each of the units of pixels 806. The input 808 may thus comprise an instruction for the image sensor which is transmitted via an MIPI interface. In an additional implementation, the instruction may be sent to the image sensor via a wireless connection.

After the pixel array 802 with one or more units of pixels 806, each of which may have configured electronic shutter speeds, accumulates charge (e.g., charge proportional to a light intensity and/or exposure time), the charge may be converted into an analog voltage (e.g., charge-to-voltage conversion). Next, the front-facing image sensor 702 may sample and hold the voltage, as well as perform an analog-to-digital conversion using one or more ADCs 812 (e.g., column parallel readout) to generate digital values. Responsive to the analog-to-digital conversion, the digital values can be transmitted to pixel line buffers 814 (e.g., shift registers) to facilitate a readout process (e.g., digital values shifted out or read out row by row). Further, the front-facing image sensor 702 can output 816 raw pixel data via an MIPI interface of the one or more MIPI interfaces 502 so the image signal processor 306 (e.g., the 3A engine 602) can do further image processing (e.g., noise reduction, sharpening, color enhancement) and/or one or more processors 302 can cause a successive frame 718 (illustrated in FIG. 7) to be presented at a display 322.

In implementations, as illustrated in FIG. 7, the image capture manager 220 can capture a later frame 720 (after successive frame 718) and can repeat one or more operations of generating a downsampled grayscale image, detecting one or more objects, applying one or more object boundaries, collecting luminous level statistical information, zoning, and adjusting an electronic shutter speed. The image capture manager 220 can repeat one or more of these operations in response to, for example, detecting a scene change, detecting a new object, after a preset number of intervening frames between the successive frame 718 and the later frame 720, after a preset amount of time, detected movement of the image-capturing device 202, or so on. For example, as illustrated in FIG. 7, the image capture manager 220 repeats these operations based on a detection of a new object (e.g., a dog) in the later frame 720. In additional implementations, newly detected objects may be regarded as a scene change by the image capture manager 220. In still further implementations, the image capture manager 220 can detect biological matter, including trees, in a scene and zone the biological matter as well.

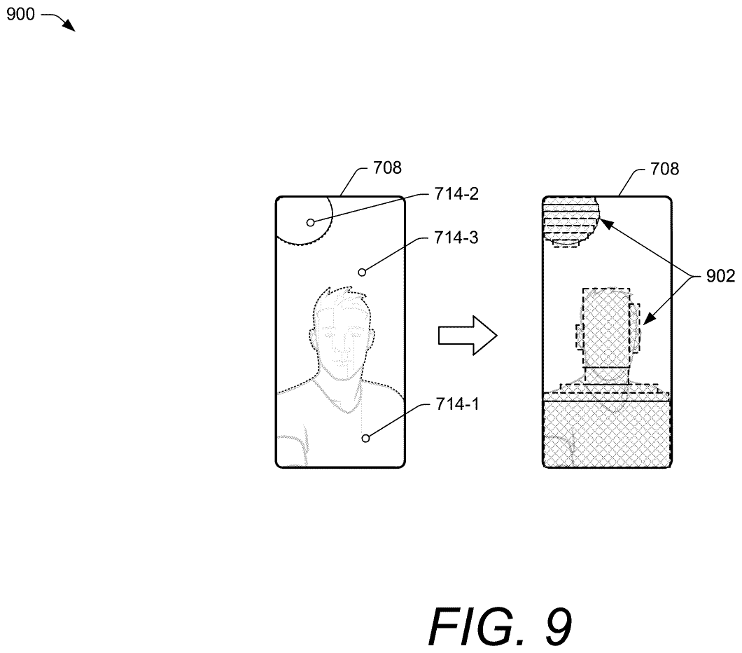

FIG. 9 illustrates an additional example implementation 900 of the image capture manager 220 zoning the frame 708 into multiple zones. As illustrated, the image capture manager 220, using the zoning module 610, zones the frame 708 into multiple zones 902 based on the luminous level statistical information for the regions 714 defined by the one or more object boundaries. For example, the zoning module 610 may determine zones 902 within the one or more object boundaries (e.g., tessellation) based on the luminous level statistical information. Although the zones 902 are illustrated in FIG. 9 as being rectangularly shaped, the zones 902 may be other simple shapes or complex shapes.

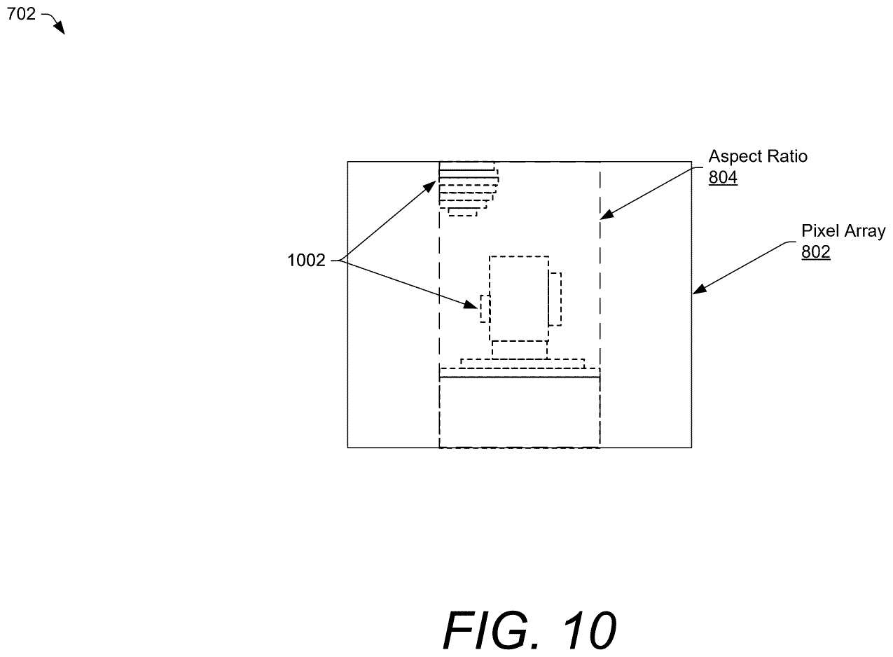

Consider, FIG. 10, which illustrates an example implementation of the front-facing image sensor 702 with the pixel array 802. In implementations, the zoning module 610 can determine corresponding units of pixels 1002 for each number of zones 902, in accordance with the aspect ratio 804 associated with the respective frame 708. For each unit of pixels 1002 and, optionally, pixels surrounding the units of pixels 1002, the electronic shutter calibration module 612 of the OBHDR manager 222 can calculate an appropiate exposure time. For example, based on the luminous level statistical information for the first region 714-1 and the second region 714-2, the electronic shutter calibration module 612 can calculate an exposure time for each unit of pixels 1002 that may enable the first region 714-1 and the second region 714-2 to be well illuminated (e.g., not overexposed, not underexposed) in a successive frame. Based on the calculation(s), the electronic shutter calibration module 612 can adjust an exposure time for each unit of pixels 1002.

Through the above-described techniques of object-based high-dynamic-range image capturing, an image capturing device (e.g., image-capturing device 202) can adjust an electronic shutter speed for one or more units of pixels (e.g., units of pixels 806, units of pixels 1002) at a pixel array (e.g., pixel array 802) of an image sensor based on luminous level statistical information of regions (e.g., regions 714) within one or more object boundaries (e.g., one or more object boundaries 712) surrounding at least one detected object. In this way, when a respective image sensor captures brightness and color information of incident light from a scene, the one or more units of pixels configured with enhanced electronic shutter speeds enable improved image capturing of the scene.

Further to the above descriptions, such object-based high-dynamic-range image capturing can provide additional benefits, including reduction of motion artifacts which are often experienced by other solutions. Moreover, object-based high-dynamic-range image capturing can decrease process runtime and power expenditure when compared to other solutions.

Although techniques have been described herein as being relevant to lighting conditions with a high dynamic range, it will be obvious to those skilled in the art that such techniques may be utilized in scenes with low dynamic ranges as well.

### Example Methods

An example method 1100 is described with reference to FIGS. 2-10 for example only and in accordance with one or more aspects of object-based high-dynamic range image capturing. This method is shown as sets of blocks that specify operations performed but are not necessarily limited to the order or combinations shown for performing the operations by the respective blocks. For example, any number of the described method blocks can be skipped or combined in any order to implement a method or an alternate method. The techniques are not limited to performance by one entity or multiple entities operating on one device.

Generally, any of the components, modules, methods, and operations described herein can be implemented using software, firmware, hardware (e.g., fixed logic circuitry), manual processing, or any combination thereof. Some operations of example methods may be described in the general context of executable instructions stored on computer-readable media 304 that is local and/or remote to a computer processing system, and implementations can include software applications, programs, functions, and the like. Alternatively or in addition, any of the functionalities described herein can be performed, at least in part, by one or more hardware logic components, such as, and without limitation, field-programmable gate arrays (FPGAs), ASICs, application-specific standard products (ASSPs), SoC systems (SoCs), complex programmable logic devices (CPLDs), and the like.

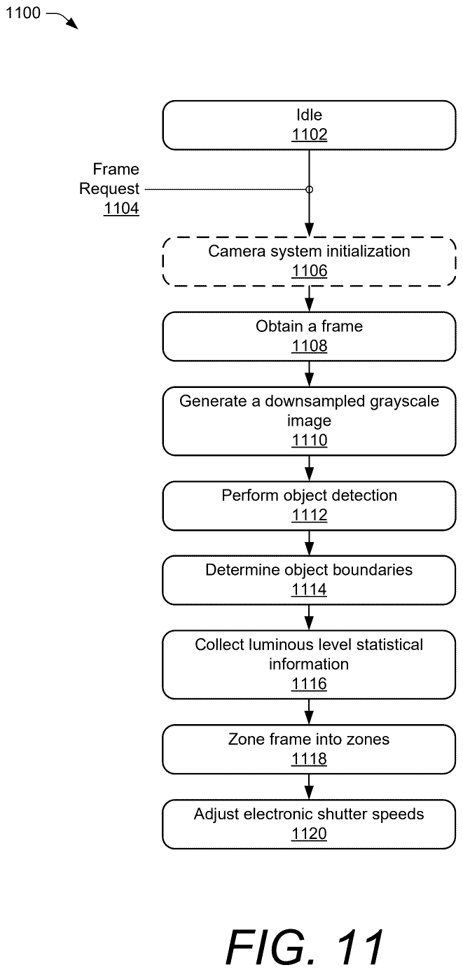

FIG. 11 illustrates the example method 1100 of object-based high-dynamic-range image capturing in accordance with some implementations. At 1102, a camera system (e.g., camera system 204) of an image-capturing device (e.g., image-capturing device 202) may be in an idle state. For example, the idle state may be an operating state of the image-capturing device during which the camera system and/or an image sensor (e.g., image sensor(s) 312) are deactivated. Upon activating an image-capturing application or boot-up of the image-capturing device, for example, one or more processors (e.g., one or more processors 302) may provide a frame request 1104 from the camera system.

At 1106, optionally, the camera system undergoes initialization. For example, an image signal processor (e.g., image signal processor 306), while executing an image capture manager (e.g., image capture manager 220), may direct a camera driver system (e.g., camera driver system 318) to adjust image-capturing settings (e.g., hardware settings, software settings) and/or activate an image sensor.

At 1108, the image-capturing device obtains a frame of a scene. For example, the camera system associated with (e.g., integrated within, operatively coupled to) the image-capturing device captures the frame (“first frame”) using an activated image sensor. The frame of the scene may be captured under pre-set hardware settings (e.g., optic settings) and/or software settings (e.g., image-processing settings). In implementations, the frame comprises raw pixel data (e.g., unprocessed and uncompressed image data, an unaltered output of individual pixels in a frame without any applied modifications).

At 1110, the image-capturing device generates a downsampled grayscale image based on the captured frame.

At 1112, the image-capturing device performs object detection. For example, the image-capturing device can perform object detection on the downsampled grayscale image. Detected objects may be objects that are prominent (e.g., large in size, distinguishable, within focus) in the captured frame.

At 1114, the image-capturing device then determines one or more object boundaries based on the detected objects. In implementations, the object boundaries include pixel coordinates of the captured frame defining at least portions of an outline of an object.

At 1116, the image-capturing device collects luminous level statistical information. In implementations, the image-capturing device collects luminous level statistical information for each region within the captured frame defined by the one or more object boundaries. In additional implementations, the image-capturing device collects luminous level statistical information for the entire image.

At 1118, the image-capturing device zones the captured frame into one or more zones. The image-capturing device may zone the captured frame into one or more zones based on at least one of the one or more object boundaries or luminous level statistical information. In implementations, the one or more zones correspond to units of pixels on a pixel array (e.g., pixel array 802).

At 1120, the image-capturing device adjusts electronic shutter speeds of one or more units of pixels based on luminous level statistical information. For example, for a first unit of pixels an image signal processor can increase an exposure time, while for a second unit of pixels the image signal processor can decrease an exposure time. In this way, when the image sensor captures a successive frame, an object and/or region of the successive frame that was previously underexposed in the first frame may be increased in exposure, while an object and/or region of the subsequent frame that was previously overexposed in the first frame may be decreased in exposure.

Although not illustrated in FIG. 11, the image-capturing device can repeat any of blocks 1108 through 1120 every “n” frames. For example, the image-capturing device can repeat blocks 1108 through 1120 every 30, 60, 90, etc. frames. That is, the process can be performed based on a number of intervening frames being captured. In this way, the object-based high-dynamic-range image capturing methods described herein can be used to maintain high image quality in variable conditions, while avoiding the additional processing that would be required to perform the process for every captured frame. The methods may be applied where the scene has not substantially changed between images. In additional examples, the image-capturing device can repeat blocks 1108 through 1120 based on a determination of a change in the scene, newly detected objects, manual camera adjustments (e.g., zoom-in, focus), and/or sensor measurements from one or more sensors (e.g., sensors 310 such as a gyroscope, accelerometer, or radar unit) that indicate movement of objects in the scene or movement of the image-capturing device. Further, the image-capturing device may do additional image processing (e.g., noise reduction, sharpening, color enhancement) at any point before, during, and/or after the method 1100. In addition, one or more processors may cause a frame (e.g., a first frame, a successive frame) to be presented at a display.

### Example Computing System

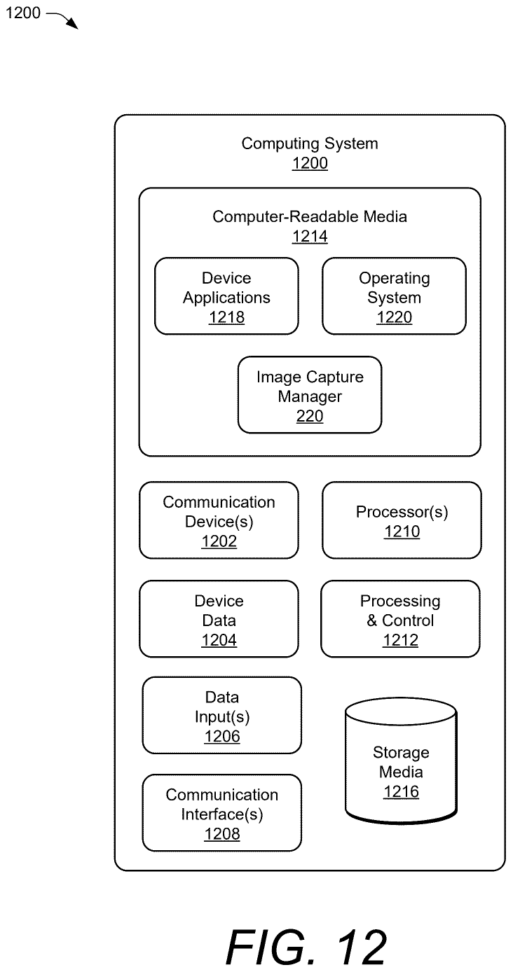

FIG. 12 illustrates various components of an example computing system 1200 that can be implemented as any type of client, server, and/or electronic device as described with reference to the previous FIGS. 1-11 to implement object-based high-dynamic-range image capturing.

The computing system 1200 includes communication devices 1202 that enable wired and/or wireless communication of device data 1204 (e.g., radar data, authentication data, reference data, received data, data that is being received, data scheduled for broadcast, and data packets of the data). The device data 1204 or other device content can include configuration settings of the device, media content stored on the device, and/or information associated with a user of the device (e.g., an identity of a person within a radar field or customized air gesture data). Media content stored on the computing system 1200 can include any type of radar, biometric, audio, video, and/or image data. The computing system 1200 includes one or more data inputs 1206 via which any type of data, media content, and/or inputs can be received, such as human utterances, interactions with a radar field, touch inputs, user-selectable inputs or interactions (explicit or implicit), messages, music, television media content, recorded video content, and any other type of audio, video, and/or image data received from any content and/or data source.

The computing system 1200 also includes communication interfaces 1208, which can be implemented as any one or more of a serial and/or a parallel interface, a wireless interface, any type of network interface, a modem, and any other type of communication interface. The communication interfaces 1208 provide a connection and/or communication links between the computing system 1200 and a communication network by which other electronic, computing, and communication devices communicate data with the computing system 1200.

The computing system 1200 includes one or more processors 1210 (e.g., any of microprocessors, controllers, or other controllers) that can process various computer-executable instructions to control the operation of the computing system 1200 and to enable techniques for, or in which can be implemented, object-based high-dynamic-range image capturing. Alternatively or additionally, the computing system 1200 can be implemented with any one or combination of hardware, firmware, or fixed logic circuitry that is implemented in connection with processing and control circuits, which are generally identified at 1212. Although not shown, the computing system 1200 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The computing system 1200 also includes computer-readable media 1214, such as one or more memory devices that enable persistent and/or non-transitory data storage (e.g., in contrast to mere signal transmission), examples of which include RAM, non-volatile memory (e.g., any one or more of a ROM, flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. The computing system 1200 can also include a mass storage media device (storage media) 1216.

The computer-readable media 1214, which may be stored in data storage mechanisms, can include device data 1204 as well as various device applications 1218 and any other types of information and/or data related to operational aspects of the computing system 1200. For example, an operating system 1220 can be maintained as a computer application with the computer-readable media 1214 and executed on the processors 1210. The device applications 1218 may include an image capture manager 220, in any form of a control application, a software application, signal-processing and control modules, code that is native to a particular device, an abstraction module, a machine-learned model, and so on. The device applications 1218 may also include system components, engines, modules, or managers to implement object-based high-dynamic-range image capturing. The computing system 1200 may also include, or have access to, one or more machine-learning systems.

In one example, the example computing system 1200 is a server system having an image capture manager (e.g., image capture manager 220) with an OBHDR manager (e.g., OBHDR manager 222). The image capture manager of the server system is configured to obtain one or more frames from, for example, a client device and perform one or more operations of object-based high-dynamic-range image capturing. For instance, referring to FIG. 9 as an example only, the server system can receive a first frame (e.g., respective frame 708) via a wireless connection to an image-capturing device (e.g., image-capturing device 202). The server system can then generate a downsampled grayscale image, perform object detection, determine one or more object boundaries, collect luminous level statistical information within one or more regions (e.g., regions 714), zone the first frame (e.g., zones 902), and adjust an electronic shutter speed of the image-capturing device by transmitting a command to one or more processors via the wireless connection.

### Additional Examples

In the following section, additional examples are provided.

Example 1: A method for scenic high-dynamic-range image capturing, the method comprising: generating a first downsampled grayscale image based on a first frame, the first frame comprising pixel data of a first scene; performing object detection on the first downsampled grayscale image sufficient to detect one or more objects within the first scene; determining one or more first object boundaries for each of the one or more detected objects; collecting, responsive to the determination of the one or more first object boundaries, luminous level statistical information of regions defined by each of the one or more first object boundaries; zoning the first frame based on the luminous level statistical information sufficient to form at least one zone, the at least one zone corresponding to at least one first unit of pixels of a pixel array at an image sensor; and adjusting an electronic shutter speed of the at least one first unit of pixels sufficient to increase or decrease an exposure time.

Example 2: The method of example 1, further comprising: prior to generating the first downsampled grayscale image, receiving the first frame via a wireless connection, and wherein adjusting the electronic shutter speed of the at least one first unit of pixels comprises transmitting an instruction to the image sensor via the wireless connection.

Example 3: The method of example 1, further comprising: prior to generating the downsampled grayscale image, directing, via a wired connection, the image sensor to capture the first frame, the wired connection comprising a mobile industry processor interface (MIPI) interface, and wherein adjusting the electronic shutter speed of the at least one unit of pixels comprises transmitting an instruction to the image sensor via the MIPI interface.

Example 4: The method of any one of the preceding examples, further comprising: responsive to adjusting the electronic shutter speed of the at least one unit of pixels, directing the image sensor to capture a second frame.

Example 5: The method of example 4, wherein the second frame is an immediately succeeding frame captured at the pixel array of the image sensor, the method further comprising: presenting the second frame at a display.

Example 6: The method of any one of the preceding examples, further comprising: directing the image sensor to capture a third frame, the third frame comprising pixel data of a second scene; generating a second downsampled grayscale image based on the third frame; performing object detection on the second downsampled grayscale image sufficient to detect one or more objects within the second scene; determining one or more second object boundaries for each of the one or more detected objects within the second scene; collecting, responsive to the determination of the one or more second object boundaries, luminous level statistical information of regions defined by each of the one or more second object boundaries; zoning the third frame based on the luminous level statistical information sufficient to form at least one zone, the at least one zone corresponding to at least one second unit of pixels of the pixel array at the image sensor; and adjusting an electronic shutter speed of the at least one second unit of pixels.

Example 7: The method of example 6, wherein: the third frame is captured after one or more intervening frames; and the generation of the second downsampled grayscale image, the performance of the object detection, the determination of the one or more second object boundaries, the collection of the luminous level statistical information, the zoning of the third frame, and the adjustment of the electronic shutter speed are based on a number of intervening frames captured between the first frame and the third frame.

Example 8: The method of any of example 6 or example 7, wherein the second scene is the same as the first scene.

Example 9: The method of example 6, further comprising: prior to generating the second downsampled grayscale image, receiving an indication of a change in scene between the first scene and the second scene, and wherein the generation of the second downsampled grayscale image, the performance of the object detection, the determination of the one or more second object boundaries, the collection of the luminous level statistical information, the zoning of the third frame, and the adjustment of the electronic shutter speed are based on the indication of the change in scene between the first scene and the second scene.

Example 10: The method of example 6, further comprising: prior to generating the second downsampled grayscale image, receiving an indication of a newly detected object, and wherein the generation of the second downsampled grayscale image, the performance of the object detection, the determination of the one or more second object boundaries, the collection of the luminous level statistical information, the zoning of the third frame, and the adjustment of the electronic shutter speed are based on the indication of the newly detected object.

Example 11: The method of any one of the preceding examples, wherein performing object detection further comprises scenery detection, the scenery comprising landscapes, bodies of water, clouds, a sky, stars, or biological matter.

Example 12: The method of any one of any of the previous examples, further comprising: adjusting an electronic shutter speed for one or more pixels of the pixel array surrounding the at least one unit of pixels or the at least one second unit of pixels.

Example 13: The method of any one of the preceding examples, wherein: the object boundaries define at least one of simple shapes or complex shapes; and the at least one zone defines simple shapes.

Example 14: The method of any one of the preceding examples, wherein: the at least one zone surrounds the one or more first object boundaries; and/or the at least one zone fits within the one or more first object boundaries.

Example 15: A computing system comprising: a pixel array of an image sensor; one or more processors; and computer-readable instructions which, when executed by the processor, cause the computing system to perform the method of any one of the preceding examples.

### Conclusion

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying Drawings and terms discussed herein may be indicative of one or more items or terms, and thus reference may be made interchangeably to single or plural forms of the items and terms in this written description.

Although implementations for object-based high-dynamic-range image capturing have been described in language specific to certain features and/or methods, the subject of the appended Claims is not necessarily limited to the specific features or methods described. Rather, the specific features and methods are disclosed as example implementations for object-based high-dynamic-range image capturing.

1. A method for scenic high-dynamic-range image capturing, the method comprising:
generating a first downsampled grayscale image based on a first frame, the first frame comprising pixel data of a first scene;
performing object detection on the first downsampled grayscale image sufficient to detect one or more objects within the first scene;
determining one or more first object boundaries for each of the one or more detected objects;
collecting, responsive to the determination of the one or more first object boundaries, luminous level statistical information of regions defined by each of the one or more first object boundaries;
zoning the first frame based on the luminous level statistical information sufficient to form at least one zone, the at least one zone corresponding to at least one first unit of pixels of a pixel array at an image sensor; and
adjusting an electronic shutter speed of the at least one first unit of pixels sufficient to increase or decrease an exposure time.

2. The method of claim 1, further comprising:
prior to generating the first downsampled grayscale image, receiving the first frame via a wireless connection, and wherein adjusting the electronic shutter speed of the at least one first unit of pixels comprises transmitting an instruction to the image sensor via the wireless connection.

3. The method of claim 1, further comprising:
prior to generating the downsampled grayscale image, directing, via a wired connection, the image sensor to capture the first frame, the wired connection comprising a mobile industry processor interface (MIPI) interface, and wherein adjusting the electronic shutter speed of the at least one unit of pixels comprises transmitting an instruction to the image sensor via the MIPI interface.

4. The method of claim 1, further comprising:
responsive to adjusting the electronic shutter speed of the at least one unit of pixels, directing the image sensor to capture a second frame.

5. The method of claim 4, wherein the second frame is an immediately succeeding frame captured at the pixel array of the image sensor, the method further comprising:
presenting the second frame at a display.

6. The method of claim 1, further comprising:
directing the image sensor to capture a third frame, the third frame comprising pixel data of a second scene;
generating a second downsampled grayscale image based on the third frame;
performing object detection on the second downsampled grayscale image sufficient to detect one or more objects within the second scene;
determining one or more second object boundaries for each of the one or more detected objects within the second scene;
collecting, responsive to the determination of the one or more second object boundaries, luminous level statistical information of regions defined by each of the one or more second object boundaries;
zoning the third frame based on the luminous level statistical information sufficient to form at least one zone, the at least one zone corresponding to at least one second unit of pixels of the pixel array at the image sensor; and
adjusting an electronic shutter speed of the at least one second unit of pixels.

7. The method of claim 6, wherein:
the third frame is captured after one or more intervening frames; and
the generation of the second downsampled grayscale image, the performance of the object detection, the determination of the one or more second object boundaries, the collection of the luminous level statistical information, the zoning of the third frame, and the adjustment of the electronic shutter speed are based on a number of intervening frames captured between the first frame and the third frame.

8. The method of claim 7, wherein the second scene is the same as the first scene.

9. The method of claim 8, further comprising:
prior to generating the second downsampled grayscale image, receiving an indication of a change in scene between the first scene and the second scene, and wherein the generation of the second downsampled grayscale image, the performance of the object detection, the determination of the one or more second object boundaries, the collection of the luminous level statistical information, the zoning of the third frame, and the adjustment of the electronic shutter speed are based on the indication of the change in scene between the first scene and the second scene.

10. The method of claim 8, further comprising:
prior to generating the second downsampled grayscale image, receiving an indication of a newly detected object, and wherein the generation of the second downsampled grayscale image, the performance of the object detection, the determination of the one or more second object boundaries, the collection of the luminous level statistical information, the zoning of the third frame, and the adjustment of the electronic shutter speed are based on the indication of the newly detected object.

11. The method of claim 1, wherein performing object detection further comprises scenery detection, the scenery comprising landscapes, bodies of water, clouds, a sky, stars, or biological matter.

12. The method of claim 11, further comprising:
adjusting an electronic shutter speed for one or more pixels of the pixel array surrounding the at least one unit of pixels or the at least one second unit of pixels.

13. The method of claim 1, wherein:
the object boundaries define at least one of simple shapes or complex shapes; and
the at least one zone defines simple shapes.

14. The method of claim 1, wherein:
the at least one zone surrounds the one or more first object boundaries; and/or
the at least one zone fits within the one or more first object boundaries.

15. A computing system comprising:
a pixel array of an image sensor;
one or more processors; and
computer-readable instructions which, when executed by the processor, cause the computing system to:
generate a first downsampled grayscale image based on a first frame, the first frame comprising pixel data of a first scene;
perform object detection on the first downsampled grayscale image sufficient to detect one or more objects within the first scene;
determine one or more first object boundaries for each of the one or more detected objects;
collect, responsive to the determination of the one or more first object boundaries, luminous level statistical information of regions defined by each of the one or more first object boundaries;
zone the first frame based on the luminous level statistical information sufficient to form at least one zone, the at least one zone corresponding to at least one first unit of pixels of a pixel array at an image sensor; and
adjust an electronic shutter speed of the at least one first unit of pixels sufficient to increase or decrease an exposure time.

16. The computing system of claim 15, wherein the computer-readable instructions further cause the computing system to:
prior to the generation of the first downsampled grayscale image, receive the first frame via a wireless connection, and wherein the adjustment of the electronic shutter speed of the at least one first unit of pixels comprises transmitting an instruction to the image sensor via the wireless connection.

17. The computing system of claim 15, wherein the computer-readable instructions further cause the computing system to:
prior to the generation of the downsampled grayscale image, direct, via a wired connection, the image sensor to capture the first frame, the wired connection comprising a mobile industry processor interface (MIPI) interface, and wherein the adjustment of the electronic shutter speed of the at least one unit of pixels comprises transmitting an instruction to the image sensor via the MIPI interface.

18. The computing system of claim 15, wherein the computer-readable instructions further cause the computing system to:
responsive to the adjustment of the electronic shutter speed of the at least one unit of pixels, direct the image sensor to capture a second frame.

19. The computing system of claim 18, wherein the second frame is an immediately succeeding frame captured at the pixel array of the image sensor, and wherein the computer-readable instructions further cause the computing system to:
presenting the second frame at a display.

20. The computing system of claim 15, wherein the computer-readable instructions further cause the computing system to:
direct the image sensor to capture a third frame, the third frame comprising pixel data of a second scene;
generate a second downsampled grayscale image based on the third frame;
perform object detection on the second downsampled grayscale image sufficient to detect one or more objects within the second scene;
determine one or more second object boundaries for each of the one or more detected objects within the second scene;
collect, responsive to the determination of the one or more second object boundaries, luminous level statistical information of regions defined by each of the one or more second object boundaries;
zone the third frame based on the luminous level statistical information sufficient to form at least one zone, the at least one zone corresponding to at least one second unit of pixels of the pixel array at the image sensor; and
adjust an electronic shutter speed of the at least one second unit of pixels.
